(19) United States
(12) Patent Application Publication
(10) Pub. No.: US 2026/0266587 A1
(43) Pub. Date: Sep. 10, 2026

(54) MAGNETIC SINGLE-TURN ANGLE MEASURMENT DEVICE

(71) Applicant: Hengstler GmbH, Aldingen (DE)

(72) Inventors: Thorsten Blust, Deißlingen (DE); Andreas Wöhrstein, Koenigsfeld (DE); Nico Hauser, Spaichingen (DE)

(21) Appl. No.: 19/556,264

(22) Filed: Mar. 4, 2026

Related U.S. Application Data
(60) Provisional application No. 63/767,456, filed on Mar. 5, 2025.
(60) Provisional application No. 63/767,457, filed on Mar. 5, 2025.
(60) Provisional application No. 63/767,462, filed on Mar. 5, 2025.
(60) Provisional application No. 63/767,467, filed on Mar. 5, 2025.

(51) Int. Cl. G01B 7/30

(52) U.S. Cl. CPC G01B 7/30

(57) ABSTRACT

Systems, apparatuses, and methods provide for an angle measurement device for measuring revolutions of a shaft. The angle measurement device includes a gearbox carrier housing, a geared main shaft, a substrate, and a geared drive wheel. The gearbox carrier housing has a shaft aperture therein. The geared main shaft is rotatably received through the shaft aperture in the gearbox carrier housing. The geared drive wheel is located in the gearbox carrier housing and directly coupled to the geared main shaft. The geared drive wheel includes a single-turn permanent magnet magnetically associated with the single-turn Hall sensor and/or the geared main shaft further includes a single-turn permanent magnet. The substrate is coupled to the gearbox carrier housing, the substrate having a single-turn Hall sensor to sense single-turn motion of the geared main shaft and/or to sense single-turn motion of the geared main shaft.

### FIELD

The instant disclosure relates generally to systems, apparatuses, and methods for angle measurement devices for measuring revolutions of a shaft. In particular, embodiments of the instant disclosure relate to systems, apparatuses, and methods for magnetic single-turn angle measurement devices for measuring revolutions of a shaft.

### BACKGROUND

In the field of position detection of drives, angle measuring devices can record the position value, number of revolutions, and/or speed and feed them into a control loop. The position of a shaft is currently detected via an optical, inductive, magnetic, or capacitive single-turn scan at the perimeter of the drive shaft or centrically to it and, if necessary, detected by a magnetic or optical multi-turn scan or a Wiegand module and fed into the control loop.

Similarly, angle measuring devices can scan a redundant single-turn value and feed it into the control loop. The position is currently detected via an optical, inductive, magnetic, or capacitive single-turn scan at the off-center of the drive shaft or centrically to it and, if necessary, a magnetic or optical multi-turn scan or a Wiegand module and fed into the control loop. For redundant single-turn scanning, a system is usually used that also scans around the drive shaft or centrically to it.

Additionally, in the field of position detection of drives, the positioning of the shaft is usually taken up by two ball bearings on the shaft and on the housing. Alternatively, the shaft is held to the drive shaft by a fit or cone.

### SUMMARY

Advantageously, some implementations discussed herein provide an angle measurement device that operates without the use of an encoder code disc, instead operating with one or more single-turn Hall sensors that are utilized to sense single-turn motion of a geared main shaft.

As will be described in greater detail below, in some implementations discussed herein, systems, apparatuses, and methods provide for an angle measurement device for measuring revolutions of a shaft. The angle measurement device includes a gearbox carrier housing, a geared main shaft, a substrate, and a geared drive wheel. The gearbox carrier housing has a shaft aperture therein. The geared main shaft is rotatably received through the shaft aperture in the gearbox carrier housing. The geared drive wheel is located in the gearbox carrier housing and directly coupled to the geared main shaft. The geared drive wheel includes a single-turn permanent magnet magnetically associated with the single-turn Hall sensor and/or the geared main shaft further includes a single-turn permanent magnet. The substrate is coupled to the gearbox carrier housing, the substrate having a single-turn Hall sensor to sense single-turn motion of the geared main shaft and/or to sense single-turn motion of the geared main shaft.

In one example, an angle measurement device for measuring revolutions of a shaft includes a gearbox carrier housing, a geared main shaft, a substrate, and a geared drive wheel. The gearbox carrier housing has a shaft aperture therein. The geared main shaft is rotatably received through the shaft aperture in the gearbox carrier housing. The substrate is coupled to the gearbox carrier housing. The substrate has a single-turn Hall sensor to sense single-turn motion of the geared main shaft. The geared drive wheel is located in the gearbox carrier housing and directly coupled to the geared main shaft. The geared drive wheel includes a single-turn permanent magnet magnetically associated with the single-turn Hall sensor.

In a further example, a method includes rotatably receiving a geared main shaft through a shaft aperture in a gearbox carrier housing. Single-turn motion of the geared main shaft is sensed via a single-turn Hall sensor located on a substrate coupled to the gearbox carrier housing. The single-turn Hall sensor is magnetically associated with a single-turn permanent magnet embedded in a geared drive wheel. The geared drive wheel is located in the gearbox carrier housing and directly coupled to the geared main shaft. An absolute position of the geared main shaft is detected based on the sensed single-turn motion of the geared main shaft from the single-turn Hall sensor.

In another example, an angle measurement device for measuring revolutions of a shaft includes a gearbox carrier housing, a geared main shaft, a substrate, and a shaft flange bearing. The gearbox carrier housing has a shaft aperture therein. The geared main shaft is rotatably received through the shaft aperture in the gearbox carrier housing. The geared main shaft further includes a single-turn permanent magnet. The substrate is coupled to the gearbox carrier housing. The substrate has a single-turn Hall sensor to sense single-turn motion of the geared main shaft. The shaft flange bearing is located on the substrate facing the gearbox carrier housing. The shaft flange bearing is to receive a shaft end of the geared main shaft. The shaft flange bearing includes a shaft ring opening that mates with a shaft detent ring located on shaft end of the geared main shaft to releasably secure the geared main shaft to the shaft flange bearing.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 is an illustration of a perspective view of an angle measurement device for measuring revolutions of a geared main shaft according to an example of the instant disclosure;

FIG. 2 is an illustration of a cross section view of the angle measurement device for measuring revolutions of the geared main shaft according to an example of the instant disclosure;

FIG. 3 is an illustration of a perspective view of a substrate of the angle measurement device according to an example of the instant disclosure;

FIG. 4 is an illustration of a perspective view of a geared main shaft of the angle measurement device according to an example of the instant disclosure;

FIG. 5 is an illustration of a perspective view of another geared main shaft of the angle measurement device according to an example of the instant disclosure;

FIG. 6 is an illustration of a perspective view of a gearbox carrier housing of the angle measurement device according to an example of the instant disclosure;

FIG. 7 is an illustration of a perspective view of another gearbox carrier housing of the angle measurement device according to an example of the instant disclosure;

FIG. 8 is an illustration of a perspective view of another angle measurement device for measuring revolutions of the geared main shaft according to an example of the instant disclosure;

FIG. 9 is an illustration of a cross section view of the other angle measurement device for measuring revolutions of the geared main shaft according to an example of the instant disclosure;

FIG. 10 is an illustration of a cross section view of the other angle measurement device for measuring revolutions of the geared main shaft taken along area 10 of FIG. 9 according to an example of the instant disclosure;

FIG. 11 is an illustration of a cross section view of the other angle measurement device for measuring revolutions of the geared main shaft taken along area 11 of FIG. 9 according to an example of the instant disclosure;

FIG. 12 is an illustration of a perspective view of another substrate of the angle measurement device according to an example of the instant disclosure;

FIG. 13 is an illustration of a perspective view of another gearbox carrier housing of the angle measurement device according to an example of the instant disclosure;

FIG. 14 is a flowchart of an example of a method for measuring revolutions of a geared main shaft according to an example; and

FIG. 15 is a flowchart of another example method for measuring revolutions of a geared main shaft according to an example.

### DETAILED DESCRIPTION OF THE PRESENT EMBODIMENTS

As will be described in greater detail below, in some implementations discussed herein, systems, apparatuses, and methods provide for an angle measurement device for measuring revolutions of a shaft. The angle measurement device includes a gearbox carrier housing, a geared main shaft, a substrate, and a geared drive wheel. The gearbox carrier housing has a shaft aperture therein. The geared main shaft is rotatably received through the shaft aperture in the gearbox carrier housing. The geared drive wheel is located in the gearbox carrier housing and directly coupled to the geared main shaft. The geared drive wheel includes a single-turn permanent magnet magnetically associated with the single-turn Hall sensor and/or the geared main shaft further includes a single-turn permanent magnet. The substrate is coupled to the gearbox carrier housing, the substrate having a single-turn Hall sensor to sense single-turn motion of the geared main shaft and/or to sense single-turn motion of the geared main shaft.

Advantageously, some implementations discussed herein, the geared main shaft may not be equipped with the single-turn permanent magnet while a single-turn permanent magnet is embedded in the drive wheel. Such an embodiment provides a space-saving and cost-effective alternative to the existing systems, allowing free installation space in the center of the geared main shaft.

In another embodiment, the geared main shaft may be equipped with the single-turn permanent magnet while a single-turn permanent magnet is also embedded in the drive. Accordingly, such an implementation provides a space-saving and cost-effective design and an assembly of two redundant single-turn systems. In such an implementation, the single-turn value is recorded twice. This advantageously results in a redundant position value.

FIG. 1 is an illustration of a perspective view of an angle measurement device 100 for measuring revolutions of a geared main shaft 102 according to an example of the instant disclosure. As will be discussed in greater detail below, angle measurement device 100 includes the geared main shaft 102, a gearbox carrier housing 104, and a substrate 106.

The gearbox carrier housing 104 has a shaft aperture 108 therein. The geared main shaft 102 is rotatably received through the shaft aperture 108 in the gearbox carrier housing 104.

The substrate 106 is coupled to the gearbox carrier housing 104. In some implementations, the substrate 106 is a printed circuit board.

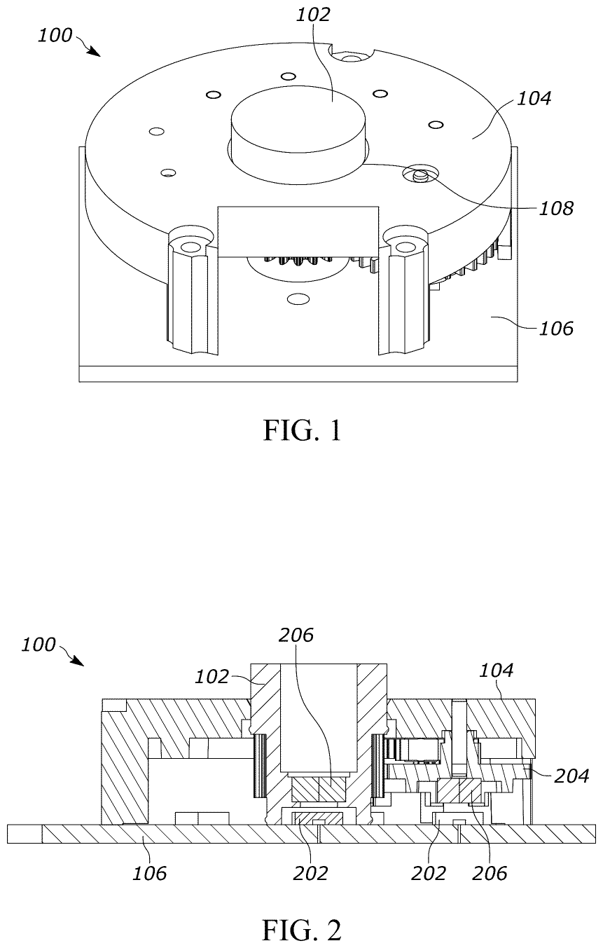

FIG. 2 is an illustration of a cross section view of the angle measurement device 100 for measuring revolutions of the geared main shaft 102 according to an example of the instant disclosure. As illustrated, the substrate 106 has one or more single-turn Hall sensors 202 to sense single-turn motion of the geared main shaft 102.

The angle measurement device 100 further includes a geared drive wheel 204 located in the gearbox carrier housing and directly coupled to the geared main shaft 102

In some implementations, the geared drive wheel 204 includes a single-turn permanent magnet 206 magnetically associated with the respective single-turn Hall sensor 202 to detect the absolute angular position of the geared main shaft 102 over one turn. Additionally, or alternatively, the geared main shaft 102 includes a single-turn permanent magnet 206 magnetically associated with the respective single-turn Hall sensor 202 to detect the absolute angular position of the geared main shaft 102 over one turn. Accordingly, in some embodiments only one of the geared main shaft 102 and the geared drive wheel 204 includes a single-turn permanent magnet 206. In other embodiments, the geared main shaft 102 and the geared drive wheel 204 each include a single-turn permanent magnet 206. For example, the geared main shaft 102 and the geared drive wheel 204 each may include a single-turn permanent magnet 206 in implementations where redundant detection of the revolutions of the geared main shaft 102 is desired.

Accordingly, in some implementations, the geared main shaft 102 includes a single-turn permanent magnet 206. In such an implementation, the substrate further has a corresponding single-turn Hall sensor 202 associated with the single-turn permanent magnet 206 of the geared main shaft 102 to sense single-turn motion of the geared main shaft 102.

In operation, the angle measurement device 100 operates without the use of an encoder code disc, as the one or more single-turn Hall sensors 202 are utilized to sense single-turn motion of the geared main shaft 102.

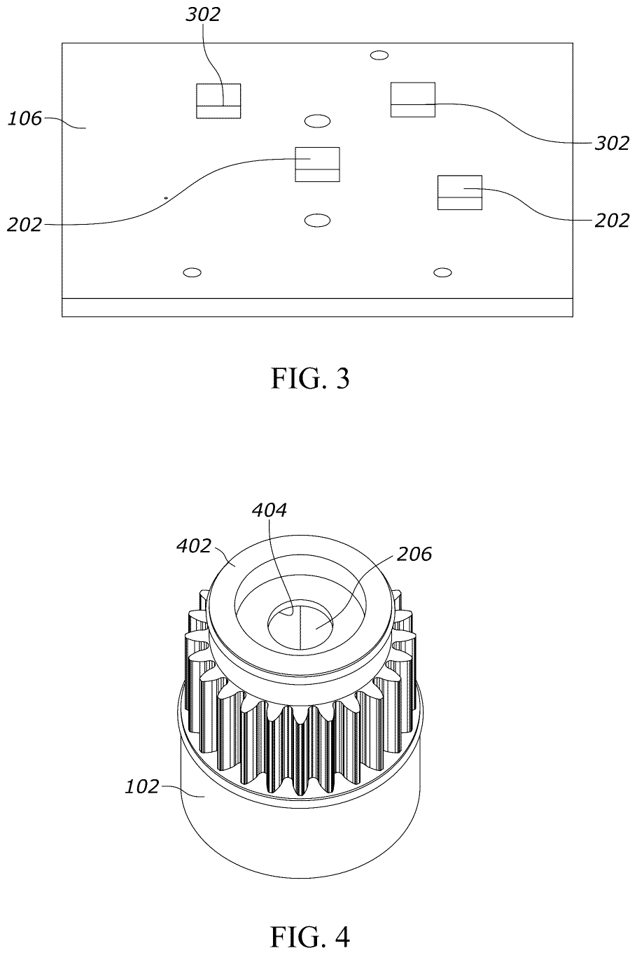

FIG. 3 is an illustration of a perspective view of a substrate 106 of the angle measurement device 100 according to an example of the instant disclosure. As illustrated, the substrate 106 has one or more single-turn Hall sensors 202 to sense single-turn motion of the geared main shaft 102. Additionally, or alternatively, the substrate 106 two or more multi-turn Hall sensors 302 to sense multi-turn motion of the geared main shaft 102.

As will be described in greater detail below, with regard to FIG. 6, the angle measurement device 100 further includes two or more reduction gears that are driven by the geared drive wheel 204 (See, e.g., FIG. 2). The two or more reduction gears may include two or more multi-turn permanent magnets magnetically associated with the two or more multi-turn Hall sensors 302, respectively.

FIG. 4 is an illustration of a perspective view of a geared main shaft 102 of the angle measurement device 100 according to an example of the instant disclosure. As illustrated, in some implementations, the geared main shaft 102 may be equipped with the second single-turn permanent magnet 206. In such an implementation, the second single-turn permanent magnet 206 is embedded in the geared main shaft 102.

In the illustrated example, the geared main shaft 102 includes an end rim 402 that faces the substrate 106 (See, e.g., FIG. 2). This end rim 402 creates a hollow space to accommodate the corresponding single-turn Hall sensor 202 (See, e.g., FIG. 2). Additionally, the geared main shaft 102 includes an opening 404 which reduces interference between the second single-turn permanent magnet 206 of the geared main shaft 102 and the corresponding single-turn Hall sensor 202 (See, e.g., FIG. 2).

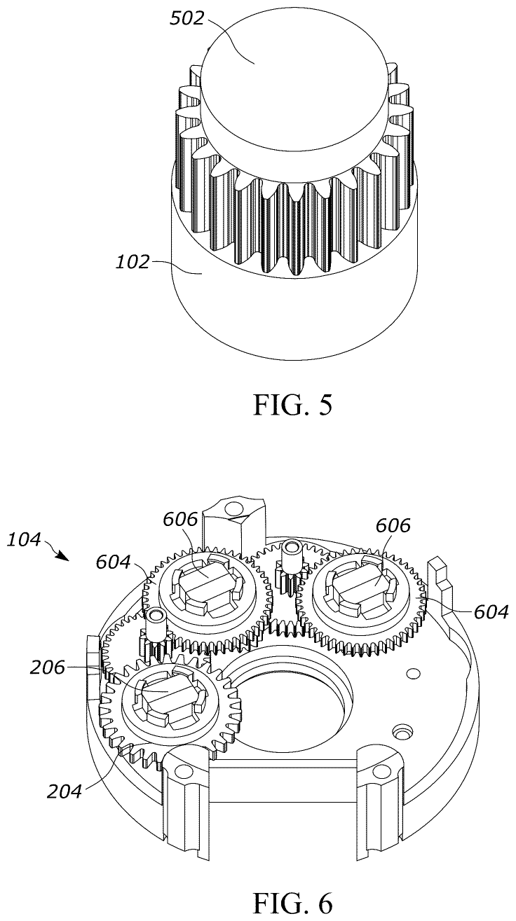

FIG. 5 is an illustration of a perspective view of another geared main shaft 102 of the angle measurement device 100 according to an example of the instant disclosure. As illustrated, in some implementations, the geared main shaft 102 may not be equipped with the single-turn permanent magnet. In such an implementation, the geared main shaft 102 may have a uniform end surface 502 that faces the substrate 106 (See, e.g., FIG. 2). In such an implementation, the corresponding single-turn Hall sensor 202 (See, e.g., FIG. 2) may also be removed.

FIG. 6 is an illustration of a perspective view of a gearbox carrier housing 104 of the angle measurement device 100 according to an example of the instant disclosure. As illustrated, in some implementations, the single-turn permanent magnet 206 is embedded in the drive wheel 204.

As described above, the angle measurement device 100 further includes two or more reduction gears 604 that are driven by the geared drive wheel 204. The two or more reduction gears 604 may include two or more multi-turn permanent magnets 606 magnetically associated with the two or more multi-turn Hall sensors 302 (See FIG. 3), respectively.

In some implementations, the two or more multi-turn permanent magnets 606 are embedded in the two or more reduction gears 604, respectively.

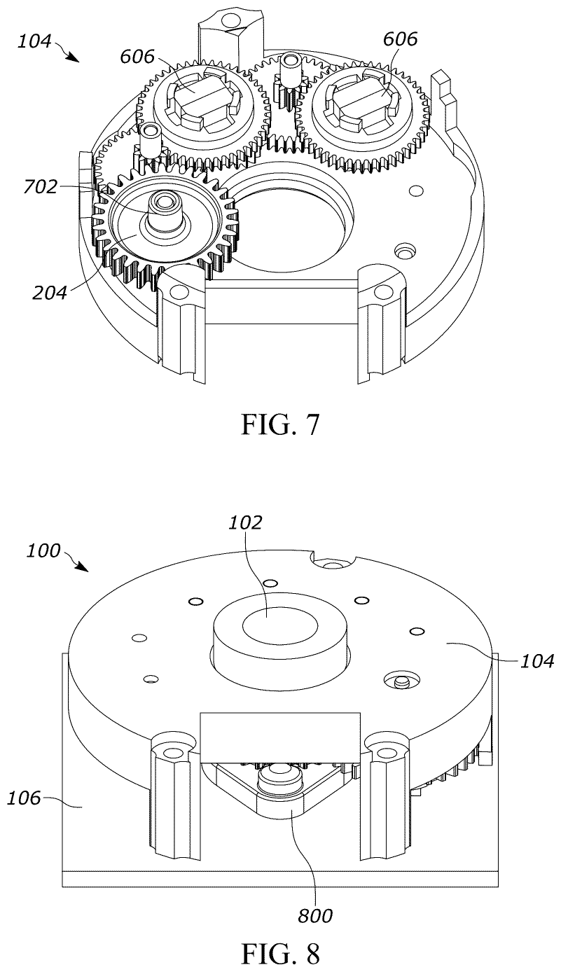

FIG. 7 is an illustration of a perspective view of another gearbox carrier housing 104 of the angle measurement device 100 according to an example of the instant disclosure. As illustrated, in some implementations, the geared drive wheel 204 may not be equipped with the single-turn permanent magnet. In such an implementation, the geared drive wheel 204 may have an axis 702 that rotatably couples to the substrate 106 (See, e.g., FIG. 2). In such an implementation, the corresponding single-turn Hall sensor 202 (See, e.g., FIG. 2) may also be removed.

FIG. 8 is an illustration of a perspective view of another angle measurement device 100 for measuring revolutions of the geared main shaft 102 according to an example of the instant disclosure. As illustrated, angle measurement device 100 includes a shaft flange bearing 800. As used herein, the term “flange bearing” refers to mounted bearings with a flange on one end, used to securely position and support rotating shafts perpendicular to a mounting surface. The shaft flange bearing 800 is located on the substrate 106 facing the gearbox carrier housing 104.

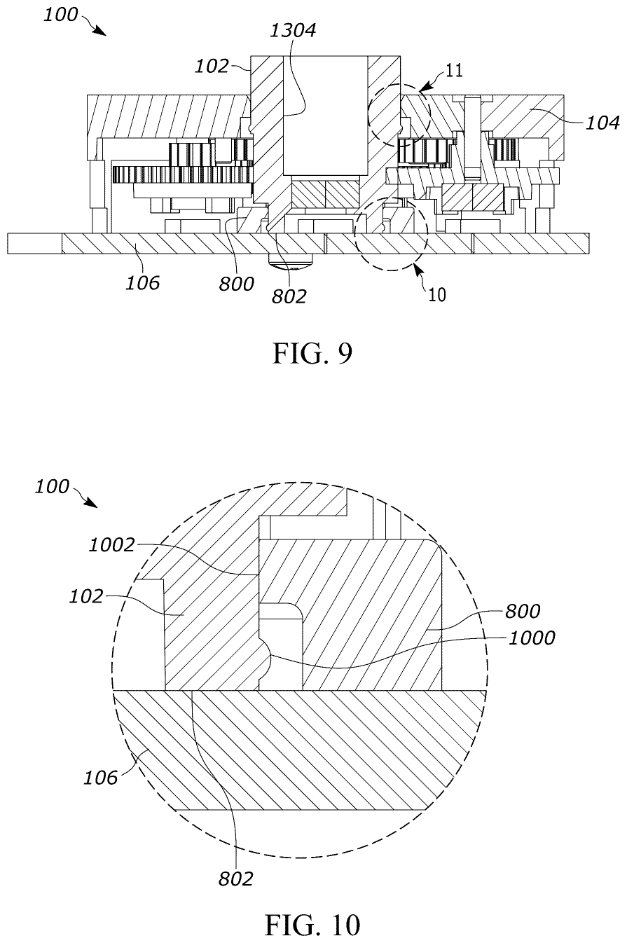

FIG. 9 is an illustration of a cross section view of the other angle measurement device 100 for measuring revolutions of the geared main shaft 102 according to an example of the instant disclosure. As illustrated, the shaft flange bearing 800 is to receive a shaft end 802 of the geared main shaft 102.

FIG. 10 is an illustration of a cross section view of the other angle measurement device 100 for measuring revolutions of the geared main shaft 102 taken along area 10 of FIG. 9 according to an example of the instant disclosure. As illustrated, the shaft flange bearing 800 includes a shaft ring 1002 opening that mates with a shaft detent ring 1000 located on shaft end 802 of the geared main shaft 102 to releasably secure the geared main shaft 102 to the shaft flange bearing 800.

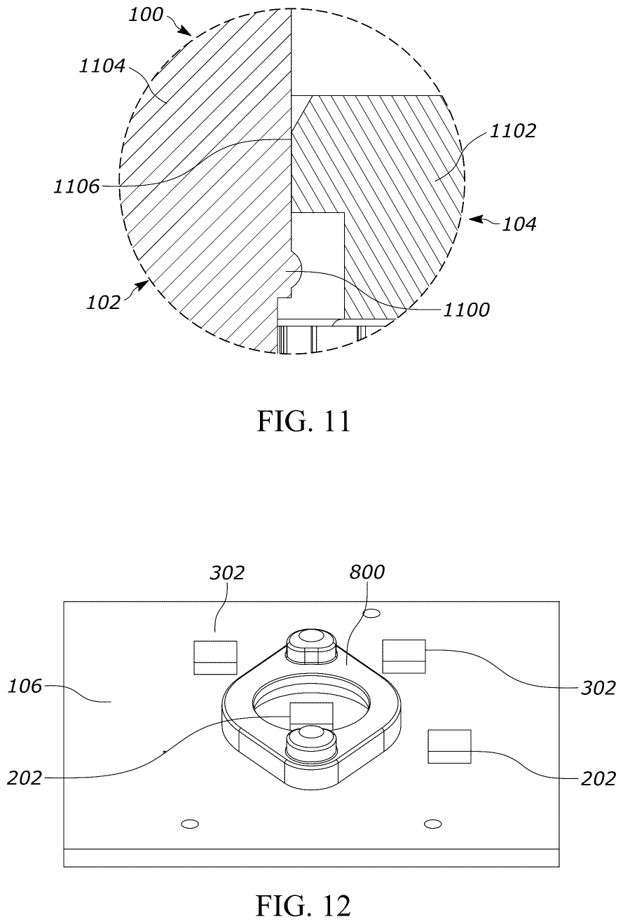

FIG. 11 is an illustration of a cross section view of the other angle measurement device 100 for measuring revolutions of the geared main shaft 102 taken along area 11 of FIG. 9 according to an example of the instant disclosure. As illustrated, a snap-in feature 1002 is located in the gearbox carrier housing 104. The snap-in feature 1002 is to receive a main body 1104 of the geared main shaft 102. The snap-in feature 1002 includes a body ring opening 1106 in integrated plain bearing 1102 that mates with a body detent ring 1100 located on the main body 1104 of the geared main shaft 102 to releasably secure the geared main shaft 102 to the gearbox carrier housing 104. As used herein, the term “plain bearing” refers to journal bearings, bushings, or sliding bearings, which include a sliding surface without rolling elements.

FIG. 12 is an illustration of a perspective view of another substrate 106 of the angle measurement device 100 according to an example of the instant disclosure. As illustrated, shaft flange bearing 800 is located on the substrate 106 facing the gearbox carrier housing 104. The shaft flange bearing 800 is positioned to surround the single-turn Hall sensor 202 associated with the geared main shaft 102 (See, e.g., FIG. 9).

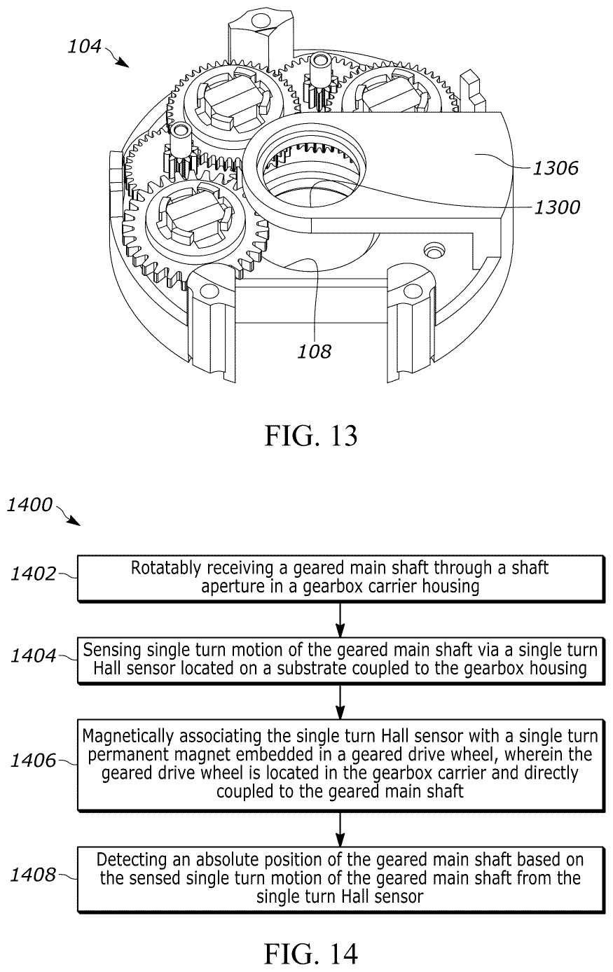

FIG. 13 is an illustration of a perspective view of another gearbox carrier housing 104 of the angle measurement device 100 according to an example of the instant disclosure. As illustrated, the gearbox carrier housing 104 includes the shaft aperture 108 (e.g., to receive the geared main shaft 102 therethrough (See, e.g., FIG. 9)). The gearbox carrier housing 104 includes an integrated flange bearing 1300 (e.g., as a replacement for flange bearing 800) located in alignment with the shaft aperture 108 to receive a shaft end 1304 (See, e.g., FIG. 9) of the geared main shaft 102 and an arm 1306 that extends partially across the gearbox carrier housing 104 to hold the integrated flange bearing 1300 in place. The integrated flange bearing 1300 may include a snap in feature similar to the snap in feature shown in FIG. 10 as associated with flange bearing 800.

### Magnetic Single-Turn on Drive Wheel, With or Without Additional Multi-Turn

Referring to FIGS. 1-3, 5, and 6, in one embodiment, the geared main shaft 102 may not be equipped with the single-turn permanent magnet (e.g., as illustrated in FIG. 5) while a single-turn permanent magnet 206 is embedded in the drive wheel 204 (e.g., as illustrated in FIG. 6). Such an embodiment provides a space-saving and cost-effective alternative to the existing systems, allowing free installation space in the center of the geared main shaft 102.

The angle measurement device 100, for measuring the absolute position of a shaft and/or for measuring the number of revolutions of the shaft, includes of a first code carrier in drive wheel 204 for detecting the absolute position of geared main shaft 102 (single-turn detection) and/or a second code carrier in two or more reduction gears 604 for detecting the number of revolutions of the geared main shaft 102 (multi-turn detection).

In some embodiments, a reduction gear, including of a number of permanent magnets and Hall sensors (or other suitable sensing elements), may be arranged between the first code carrier in drive wheel 204 for the single-turn scanning function, including of a Hall sensor (or other suitable sensing element) 202 attached to a carrier substrate 106 and a permanent magnet 206 embedded in the plastic material (or any other suitable material) in the drive wheel 204, and any other code carriers.

In some embodiments, the absolute single-turn position is detected via a permanent magnet 206 embedded in plastic (or any other suitable material) in the drive wheel 204 with an arranged Hall sensor 202 on a carrier substrate 106, if necessary in conjunction with other code carriers with a reduction gear, including an arrangement of Hall sensors 302 and an arrangement of permanent magnets 606 to record the number of revolutions of the geared main shaft 102 (multi-turn detection).

The angle encoder includes a geared main shaft 102 and a drive wheel 204 with a single-turn permanent magnet 206 and a Hall sensor 202 mounted on a substrate 106 for detecting the absolute single-turn position of the geared main shaft 102. If necessary, two or more reduction gears 604 with a corresponding arrangement of Hall sensors 302 and an arrangement of two or more multi-turn permanent magnets 606 for detecting the number of revolutions of the geared main shaft 102 are provided.

In some implementations, the single-turn permanent magnet 206 for the detection of the single-turn position from the geared main shaft 102 is embedded directly in the drive wheel 204 in plastic.

In some embodiments, the scan for the absolute single-turn position on the drive wheel 204 is taken from the geared main shaft 102 with a 1:1 ratio.

In some other embodiments, the tracking for the absolute single-turn position on the drive wheel 204 is taken from the geared main shaft 102 with a ratio or reduction ratio not equal to 1:1.

In some implementations, the Hall sensors 202 for single-turn detection and Hall sensors 302 for multi-turn detection are mounted on the same side of the substrate 106.

In other implementations, the Hall sensors 202 for single-turn detection and Hall sensors 302 for multi-turn detection are mounted on different sides of the substrate 106. For example, some of the Hall sensors 202 for single-turn detection and Hall sensors 302 for multi-turn detection are located on a side of substrate 106 facing gearbox carrier housing 104 while others of the Hall sensors 202 for single-turn detection and Hall sensors 302 for multi-turn detection are located on a back-side of the substrate 106 facing away from gearbox carrier housing 104.

### Magnetic Single-Turn on Drive Shaft and Drive Wheel

Referring to FIGS. 1-4, and 6, in one embodiment, the geared main shaft 102 may be equipped with the single-turn permanent magnet (e.g., as illustrated in FIG. 4) while a single-turn permanent magnet 206 is also embedded in the drive wheel 204 (e.g., as illustrated in FIG. 6). Accordingly, such an implementation provides a space-saving and cost-effective design and assembly of two redundant single-turn systems. In such an implementation, the single-turn value is recorded twice. This results in a redundant position value.

The angle measurement device 100, for redundant measurement of the absolute position of a geared main shaft 102 and/or for measuring the number of revolutions of the geared main shaft 102, includes a first code carrier on the geared main shaft 102 for detecting the absolute position (a first single-turn detector) and a second code carrier on the drive wheel 204 for detecting the absolute position of the geared main shaft 102 (a second single-turn detector) and/or a third code carrier on two or more reduction gears 604 for detecting the number of revolutions of the geared main shaft 102 (a multi-turn detector).

The first code carrier for the single-turn sensing function includes of a Hall sensor 202 (or other suitable sensing element) attached to a carrier substrate 106 and a single-turn permanent magnet 206 embedded in the plastic material (or other suitable material) in the geared main shaft 102, or other scale attached to the geared main shaft 102 (e.g., a code disk with optical sensor or other sensor concepts attached to the geared main shaft). The second code carrier includes a Hall sensor 202 attached to a carrier substrate 106 and a single-turn permanent magnet 206 embedded in the plastic material (or other material) in the drive wheel 204. Two or more reduction gears 604 be attached to the drive wheel 204, including a number of multi-turn permanent magnets 606, the position of which is detected by an array of Hall sensors 302.

The absolute single-turn position is detected by a single-turn permanent magnet 206 embedded in plastic (or other material) in the drive wheel 204 as well as in the geared main shaft 102, each with Hall sensors 202 is arranged for each on a carrier substrate 106. If necessary, two or more reduction gears 604 with a corresponding arrangement of Hall sensors 302 and an arrangement of two or more multi-turn permanent magnets 606 for detecting the number of revolutions of the geared main shaft 102 are provided (multi-turn detection).

In such an example, the angle measurement device 100 includes a geared main shaft 102 and a drive wheel 204, each with a permanently connected single-turn permanent magnet 206 and a corresponding single-turn Hall sensors 202 sensor element attached to a substrate 106 for redundant detection of the absolute single-turn position. If necessary, two or more reduction gears 604 with a corresponding arrangement of Hall sensors 302 and an arrangement of two or more multi-turn permanent magnets 606 for detecting the number of revolutions of the geared main shaft 102 are provided.

In some implementations, the single-turn permanent magnets 206 for position detection are embedded directly in the geared main shaft 102 (for a first single-turn position detection) and directly in the drive wheel 204 (for a second single-turn position detection) in plastic (or other material).

In some examples, instead of or in addition to permanent magnets and Hall sensors for the first and/or second single-turn positions, other sensor systems such as code disks and optical sensors or capacitive or inductive systems can also be used.

In some implementations, the combination of the two single-turn sensor systems can be used as a two-channel single-turn scan for functional safety applications.

In some implementations, the Hall sensors 202 for single-turn detection and Hall sensors 302 for multi-turn detection are mounted on the same side of the substrate 106.

In other implementations, the Hall sensors 202 for single-turn detection and Hall sensors 302 for multi-turn detection are mounted on different sides of the substrate 106. For example, some of the Hall sensors 202 for single-turn detection and Hall sensors 302 for multi-turn detection are located on a side of substrate 106 facing gearbox carrier housing 104 while others of the Hall sensors 202 for single-turn detection and Hall sensors 302 for multi-turn detection are located on a back-side of the substrate 106 facing away from gearbox carrier housing 104.

### Flange Bearing

Embodiments of described below provide a space-saving and cost-effective alternative to existing systems.

Referring to FIGS. 8-12, in one embodiment, the angle measurement device 100 comprises an assembly with a rotary encoder for the bearing-less bearing of a geared main shaft 102 by a gearbox carrier housing 104 with an integrated plain bearing 1102 and a shaft flange bearing 800. In some embodiments, the geared main shaft 102 is held in the shaft flange bearing 800 with a snap lock. The geared main shaft 102 is driven by a radial rotational movement on the geared main shaft 102, which is positioned by a geared main shaft 102 in the gearbox and a shaft flange bearing 800.

In some embodiments, the angle measuring device 100 includes a geared main shaft 102, gearbox carrier housing 104 with an integrated plain bearing 1102, substrate 106, and a shaft flange bearing 800 with an integrated plain bearing.

In some implementations, the geared main shaft 102 is held in the shaft flange bearing 800 by a snap-in device. For example, the shaft flange bearing 800 includes a shaft ring 1002 opening that mates with a shaft detent ring 1000 located on shaft end 802 of the geared main shaft 102 to releasably secure the geared main shaft 102 to the shaft flange bearing 800.

In some embodiments, the geared main shaft 102 is held in the gearbox carrier housing 104 by means of a snap-in device. For example, snap-in feature 1002 includes a body ring opening 1106 in an integrated plain bearing 1102 that mates with a body detent ring 1100 located on the main body 1104 of the geared main shaft 102 to releasably secure the geared main shaft 102 to the gearbox carrier housing 104.

In some implementations, the functions of gearbox carrier housing 104 and integrated plain bearing 1102 are integrated in one part. In other implementations, gearbox carrier housing 104 and integrated plain bearing 1102 may be formed from multiple parts.

Referring to FIG. 13, in one embodiment, the functions of gearbox carrier housing 104 and shaft flange bearing 800 are integrated in one part as integrated flange bearing 1300.

FIG. 14 is a flowchart of an example of a method 1400 for angle measurement of revolutions of a shaft according to an example. The method 1400 may generally be implemented in an apparatus, such as, for example, the angle measurement device 100 (FIGS. 1-13), already discussed.

Illustrated processing block 1402 provides for rotatably receiving a geared main shaft through a shaft aperture in a gearbox carrier housing.

Illustrated processing block 1404 provides for sensing single-turn motion of the geared main shaft. For example, single-turn motion of the geared main shaft may be sensed via a single-turn Hall sensor located on a substrate coupled to the gearbox carrier housing.

Illustrated processing block 1406 provides for magnetically associating the single-turn Hall sensor with a single-turn permanent magnet embedded in a geared drive wheel. For example, the geared drive wheel may be located in the gearbox carrier housing and directly coupled to the geared main shaft.

Illustrated processing block 1408 provides for detecting an absolute position of the geared main shaft. For example, an absolute position of the geared main shaft may be detected based on the sensed single-turn motion of the geared main shaft from the single-turn Hall sensor.

Additional or alternative operations of method 1400 are described below in method 1500.

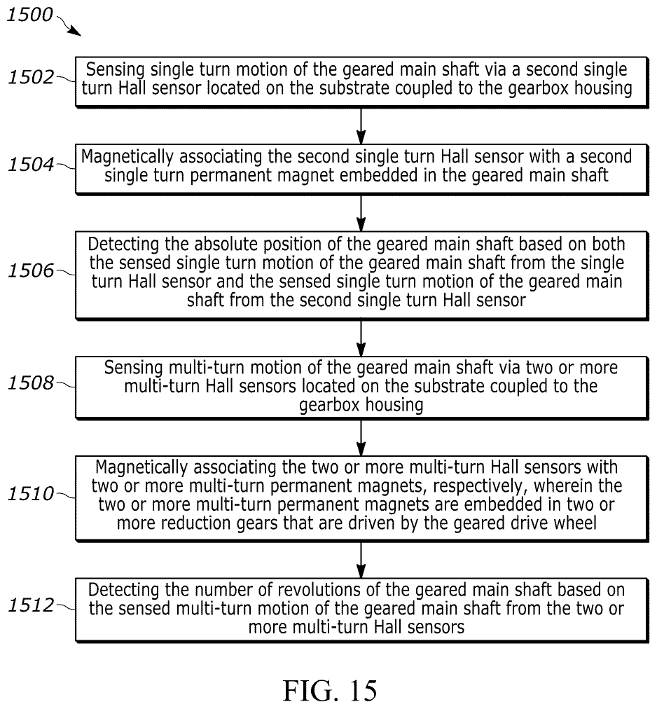

FIG. 15 is a flowchart of another example of a method 1500 for angle measurement of revolutions of a shaft according to an example. The method 1500 may generally be implemented in an apparatus, such as, for example, the angle measurement device 100 (FIGS. 1-13), already discussed.

Illustrated processing block 1502 provides for sensing single-turn motion of the geared main shaft. For example, single-turn motion of the geared main shaft may be sensed via a second single-turn Hall sensor located on the substrate coupled to the gearbox carrier housing.

Illustrated processing block 1504 provides for magnetically associating the second single-turn Hall sensor with a second single-turn permanent magnet. For example, the second single-turn permanent magnet may be embedded in the geared main shaft.

Illustrated processing block 1506 provides for detecting the absolute position of the geared main shaft. For example, the absolute position of the geared main shaft may be detected based on both the sensed single-turn motion of the geared main shaft from the single-turn Hall sensor and the sensed single-turn motion of the geared main shaft from the second single-turn Hall sensor.

Illustrated processing block 1508 provides for sensing multi-turn motion of the geared main shaft. For example, multi-turn motion of the geared main shaft may be sensed via two or more multi-turn Hall sensors located on the substrate coupled to the gearbox carrier housing.

Illustrated processing block 1510 provides for magnetically associating the two or more multi-turn Hall sensors with two or more multi-turn permanent magnets, respectively. For example, the two or more multi-turn permanent magnets are embedded in two or more reduction gears that are driven by the geared drive wheel.

Illustrated processing block 1512 provides for detecting the number of revolutions of the geared main shaft. For example, the number of revolutions of the geared main shaft may be detected based on the sensed multi-turn motion of the geared main shaft from the two or more multi-turn Hall sensors.

### Additional Notes and Examples:

Clause 1 is an angle measurement device for measuring revolutions of a shaft, comprising: a gearbox carrier housing having a shaft aperture therein; a geared main shaft rotatably received through the shaft aperture in the gearbox carrier housing; a substrate coupled to the gearbox carrier housing, the substrate having a single-turn Hall sensor to sense single-turn motion of the geared main shaft; and a geared drive wheel located in the gearbox carrier housing and directly coupled to the geared main shaft, the geared drive wheel comprising a single-turn permanent magnet magnetically associated with the single-turn Hall sensor to detect the absolute angular position of the geared main shaft over one turn.

Clause 2 includes the angle measurement device of Clause 1, wherein the single-turn permanent magnet is embedded in the drive wheel.

Clause 3 includes the angle measurement device of any one of Clauses 1 to 2, wherein the geared main shaft further comprises a second single-turn permanent magnet, and wherein the substrate further has a second single-turn Hall sensor associated with the second single-turn permanent magnet to sense single-turn motion of the geared main shaft.

Clause 4 includes the angle measurement device of Clause 3, wherein the second single-turn permanent magnet is embedded in the geared main shaft.

Clause 5 includes the angle measurement device of any one of Clauses 1 to 4, wherein the substrate further has two or more multi-turn Hall sensors to sense multi-turn motion of the geared main shaft, and further comprising: two or more reduction gears that are driven by the geared drive wheel, wherein the two or more reduction gears comprise two or more multi-turn permanent magnets magnetically associated with the two or more multi-turn Hall sensors, respectively.

Clause 6 includes the angle measurement device of Clause 5, wherein the two or more multi-turn permanent magnets are embedded in the two or more reduction gears, respectively.

Clause 7 includes the angle measurement device of any one of Clauses 1 to 6, wherein the multi-tum angle measurement device operates without the use of an encoder code disc.

Clause 8 includes the angle measurement device of any one of Clauses 1 to 7, wherein the substrate is a printed circuit board.

Clause 9 includes the angle measurement device of any one of Clauses 1 to 8, further comprising a shaft flange bearing located on the substrate facing the gearbox carrier housing, the shaft flange bearing to receive a shaft end of the geared main shaft, the shaft flange bearing including a shaft ring opening that mates with a shaft detent ring located on shaft end of the geared main shaft to releasably secure the geared main shaft to the shaft flange bearing.

Clause 10 includes the angle measurement device of any one of Clauses 1 to 9, further comprising a snap-in feature located in the gearbox carrier housing, the snap-in feature to receive a main body of the geared main shaft, the snap-in feature including a body ring opening that mates with a body detent ring located on the main body of the geared main shaft to releasably secure the geared main shaft to the gearbox carrier housing.

Clause 11 includes the angle measurement device of any one of Clauses 1 to 10, wherein the gearbox carrier housing includes the shaft aperture to receive the geared main shaft therethrough, an integrated flange bearing located in alignment with the shaft aperture to receive a shaft end of the geared main shaft, and an arm that extends partially across the gearbox carrier housing to hold the integrated flange bearing in place.

Clause 12 is a method for angle measurement comprising: rotatably receiving a geared main shaft through a shaft aperture in a gearbox carrier housing; sensing single-turn motion of the geared main shaft via a single-turn Hall sensor located on a substrate coupled to the gearbox carrier housing; magnetically associating the single-turn Hall sensor with a single-turn permanent magnet embedded in a geared drive wheel, wherein the geared drive wheel is located in the gearbox carrier housing and directly coupled to the geared main shaft; and detecting an absolute position of the geared main shaft based on the sensed single-turn motion of the geared main shaft from the single-turn Hall sensor.

Clause 13 includes the method of Clause 12, further comprising: sensing single-turn motion of the geared main shaft via a second single-turn Hall sensor located on the substrate coupled to the gearbox carrier housing; magnetically associating the second single-turn Hall sensor with a second single-turn permanent magnet embedded in the geared main shaft; and detecting the absolute position of the geared main shaft based on both the sensed single-turn motion of the geared main shaft from the single-turn Hall sensor and the sensed single-turn motion of the geared main shaft from the second single-turn Hall sensor.

Clause 14 includes the method of any one of Clauses 12 to 13, further comprising: sensing multi-turn motion of the geared main shaft via two or more multi-turn Hall sensors located on the substrate coupled to the gearbox carrier housing; magnetically associating the two or more multi-turn Hall sensors with two or more multi-turn permanent magnets, respectively, wherein the two or more multi-turn permanent magnets are embedded in two or more reduction gears that are driven by the geared drive wheel; and detecting the number of revolutions of the geared main shaft based on the sensed multi-turn motion of the geared main shaft from the two or more multi-turn Hall sensors.

Clause 15 is an angle measurement device for measuring revolutions of a shaft, comprising: a gearbox carrier housing having a shaft aperture therein; a geared main shaft rotatably received through the shaft aperture in the gearbox carrier housing, wherein the geared main shaft further comprises a single-turn permanent magnet to detect the absolute angular position of the geared main shaft over one turn; and a substrate coupled to the gearbox carrier housing, the substrate having a single-turn Hall sensor to sense single-turn motion of the geared main shaft.

Clause 16 includes the angle measurement device of Clause 15, further comprising: a shaft flange bearing located on the substrate facing the gearbox carrier housing, the shaft flange bearing to receive a shaft end of the geared main shaft, the shaft flange bearing including a shaft ring opening that mates with a shaft detent ring located on shaft end of the geared main shaft to releasably secure the geared main shaft to the shaft flange bearing

Clause 17 includes the angle measurement device of any one of Clauses 15 to 16, further comprising: a geared drive wheel located in the gearbox carrier housing and directly coupled to the geared main shaft, the geared drive wheel comprising a second single-turn permanent magnet, and wherein the substrate further has a second single-turn Hall sensor magnetically associated with the second single-turn permanent magnet to sense single-turn motion of the geared main shaft.

Clause 18 includes the angle measurement device of any one of Clauses 15 to 17, wherein the substrate further has two or more multi-turn Hall sensors to sense multi-turn motion of the geared main shaft, and further comprising: two or more reduction gears that are driven by the geared drive wheel, wherein the two or more reduction gears comprise two or more multi-turn permanent magnets magnetically associated with the two or more multi-turn Hall sensors, respectively.

Clause 19 includes the angle measurement device of any one of Clauses 15 to 18, further comprising a snap-in feature located in the gearbox carrier housing, the snap-in feature to receive a main body of the geared main shaft, the snap-in feature including a body ring opening that mates with a body detent ring located on the main body of the geared main shaft to releasably secure the geared main shaft to the gearbox carrier housing.

Clause 20 includes the angle measurement device of Clause 15, wherein the gearbox carrier housing includes the shaft aperture to receive the geared main shaft therethrough, an integrated flange bearing located in alignment with the shaft aperture to receive a shaft end of the geared main shaft, and an arm that extends partially across the gearbox carrier housing to hold the integrated flange bearing in place.

Clause 21 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. An angle measurement device for measuring revolutions of a shaft, comprising:
a gearbox carrier housing having a shaft aperture therein;
a geared main shaft rotatably received through the shaft aperture in the gearbox carrier housing;
a substrate coupled to the gearbox carrier housing, the substrate having a single-turn Hall sensor to sense single-turn motion of the geared main shaft; and
a geared drive wheel located in the gearbox carrier housing and directly coupled to the geared main shaft, the geared drive wheel comprising a single-turn permanent magnet magnetically associated with the single-turn Hall sensor to detect the absolute angular position of the geared main shaft over one turn.

2. The angle measurement device of claim 1, wherein the single-turn permanent magnet is embedded in the drive wheel.

3. The angle measurement device of claim 1, wherein the geared main shaft further comprises a second single-turn permanent magnet, and
wherein the substrate further has a second single-turn Hall sensor associated with the second single-turn permanent magnet to sense single-turn motion of the geared main shaft.

4. The angle measurement device of claim 3, wherein the second single-turn permanent magnet is embedded in the geared main shaft.

5. The angle measurement device of claim 1, wherein the substrate further has two or more multi-turn Hall sensors to sense multi-turn motion of the geared main shaft, and further comprising:
two or more reduction gears that are driven by the geared drive wheel, wherein the two or more reduction gears comprise two or more multi-turn permanent magnets magnetically associated with the two or more multi-turn Hall sensors, respectively.

6. The angle measurement device of claim 5, wherein the two or more multi-turn permanent magnets are embedded in the two or more reduction gears, respectively.

7. The angle measurement device of claim 1, wherein the multi-tum angle measurement device operates without the use of an encoder code disc.

8. The angle measurement device of claim 1, wherein the substrate is a printed circuit board.

9. The angle measurement device of claim 1, further comprising a shaft flange bearing located on the substrate facing the gearbox carrier housing, the shaft flange bearing to receive a shaft end of the geared main shaft, the shaft flange bearing including a shaft ring opening that mates with a shaft detent ring located on shaft end of the geared main shaft to releasably secure the geared main shaft to the shaft flange bearing.

10. The angle measurement device of claim 1, further comprising a snap-in feature located in the gearbox carrier housing, the snap-in feature to receive a main body of the geared main shaft, the snap-in feature including a body ring opening that mates with a body detent ring located on the main body of the geared main shaft to releasably secure the geared main shaft to the gearbox carrier housing.

11. The angle measurement device of claim 1, wherein the gearbox carrier housing includes the shaft aperture to receive the geared main shaft therethrough, an integrated flange bearing located in alignment with the shaft aperture to receive a shaft end of the geared main shaft, and an arm that extends partially across the gearbox carrier housing to hold the integrated flange bearing in place.

12. A method for angle measurement comprising:
rotatably receiving a geared main shaft through a shaft aperture in a gearbox carrier housing;
sensing single-turn motion of the geared main shaft via a single-turn Hall sensor located on a substrate coupled to the gearbox carrier housing;
magnetically associating the single-turn Hall sensor with a single-turn permanent magnet embedded in a geared drive wheel, wherein the geared drive wheel is located in the gearbox carrier housing and directly coupled to the geared main shaft; and
detecting an absolute position of the geared main shaft based on the sensed single-turn motion of the geared main shaft from the single-turn Hall sensor.

13. The method of claim 12, further comprising:
sensing single-turn motion of the geared main shaft via a second single-turn Hall sensor located on the substrate coupled to the gearbox carrier housing;
magnetically associating the second single-turn Hall sensor with a second single-turn permanent magnet embedded in the geared main shaft; and
detecting the absolute position of the geared main shaft based on both the sensed single-turn motion of the geared main shaft from the single-turn Hall sensor and the sensed single-turn motion of the geared main shaft from the second single-turn Hall sensor.

14. The method of claim 12, further comprising:
sensing multi-turn motion of the geared main shaft via two or more multi-turn Hall sensors located on the substrate coupled to the gearbox carrier housing;
magnetically associating the two or more multi-turn Hall sensors with two or more multi-turn permanent magnets, respectively, wherein the two or more multi-turn permanent magnets are embedded in two or more reduction gears that are driven by the geared drive wheel; and
detecting the number of revolutions of the geared main shaft based on the sensed multi-turn motion of the geared main shaft from the two or more multi-turn Hall sensors.

15. An angle measurement device for measuring revolutions of a shaft, comprising:
a gearbox carrier housing having a shaft aperture therein;
a geared main shaft rotatably received through the shaft aperture in the gearbox carrier housing, wherein the geared main shaft further comprises a single-turn permanent magnet to detect the absolute angular position of the geared main shaft over one turn; and
a substrate coupled to the gearbox carrier housing, the substrate having a single-turn Hall sensor to sense single-turn motion of the geared main shaft.

16. The angle measurement device of claim 15, further comprising:
a shaft flange bearing located on the substrate facing the gearbox carrier housing, the shaft flange bearing to receive a shaft end of the geared main shaft, the shaft flange bearing including a shaft ring opening that mates with a shaft detent ring located on shaft end of the geared main shaft to releasably secure the geared main shaft to the shaft flange bearing.

17. The angle measurement device of claim 15, further comprising:
a geared drive wheel located in the gearbox carrier housing and directly coupled to the geared main shaft, the geared drive wheel comprising a second single-turn permanent magnet, and
wherein the substrate further has a second single-turn Hall sensor magnetically associated with the second single-turn permanent magnet to sense single-turn motion of the geared main shaft.

18. The angle measurement device of claim 15, wherein the substrate further has two or more multi-turn Hall sensors to sense multi-turn motion of the geared main shaft, and further comprising:
two or more reduction gears that are driven by the geared drive wheel, wherein the two or more reduction gears comprise two or more multi-turn permanent magnets magnetically associated with the two or more multi-turn Hall sensors, respectively.

19. The angle measurement device of claim 15, further comprising a snap-in feature located in the gearbox carrier housing, the snap-in feature to receive a main body of the geared main shaft, the snap-in feature including a body ring opening that mates with a body detent ring located on the main body of the geared main shaft to releasably secure the geared main shaft to the gearbox carrier housing.

20. The angle measurement device of claim 15, wherein the gearbox carrier housing includes the shaft aperture to receive the geared main shaft therethrough, an integrated flange bearing located in alignment with the shaft aperture to receive a shaft end of the geared main shaft, and an arm that extends partially across the gearbox carrier housing to hold the integrated flange bearing in place.
